(19) United States
(12) Patent Application Publication
(10) Pub. No.: US 2026/0296130 A1
(43) Pub. Date: Oct. 1, 2026

(54) CLIMATE CONTROL FOR VEHICLES

(71) Applicant: Cummins Inc., Columbus, IN (US)

(72) Inventors: Timothy C. Ernst, Columbus, IN (US); James A. Zigan, Versailles, IN (US)

(21) Appl. No.: 19/562,186

(22) Filed: Mar. 10, 2026

Related U.S. Application Data
(60) Provisional application No. 63/779,372, filed on Mar. 28, 2025.

(51) Int. Cl. B60H 1/00; B60H 1/03

(52) U.S. Cl. CPC B60H 1/00378; B60H 1/00271; B60H 1/00907; B60H 1/034; B60H 2001/00307

(57) ABSTRACT

A vehicle includes a prime mover system including an engine configured to combust fuel to power propulsion of the vehicle and an electric drive configured to power propulsion of the vehicle using electrical energy from an energy storage system. A cooling stack includes a first heat exchanger operatively coupled with the engine and a second heat exchanger operatively coupled with the electric drive. A fan is configured to circulate air across the cooling stack. An electric motor is configured to drive the fan using energy from the energy storage system. A condenser is configured to be cooled by the cooling stack. A first evaporator is operatively coupled with the condenser by a first branch of a refrigeration loop. A first blower is configured to circulate air across the first evaporator and into a driver cab of the vehicle. A second evaporator is operatively coupled with the condenser by a second branch of the refrigeration loop. A second blower is configured to circulate air across the second evaporator and into a sleeper cab of the vehicle. A pump is configured to circulate refrigerant through the refrigeration loop. A valve system is configured to selectably control circulation of refrigeration through the first branch of the refrigeration loop and a second branch of the refrigeration loop. Operator controls are configured to selectably operate the first branch of the refrigeration loop to control climate of the driver cab of the vehicle and selectably operate the second branch of the refrigeration loop to control climate of the sleeper cab of the vehicle.

### BACKGROUND

The present application relates to climate control for vehicles and related apparatuses, methods, and systems. A number of proposals have been made for vehicle climate control. Existing proposals suffer from a number of drawbacks, disadvantages, shortcomings, and unmet needs including those respecting efficiency, operational flexibility, and of diagnostic information provided, among others. There remains a significant unmet need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and method of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments comprise unique vehicle climate control systems. Other embodiments comprise unique vehicle climate control processes. Further embodiments comprise unique vehicle climate control apparatuses. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example vehicle.

FIG. 2 is a schematic diagram illustrating certain aspects of an example embodiment of the vehicle of FIG. 1 including an example vehicle climate control system.

FIG. 3 is a schematic diagram illustrating certain aspects of an example embodiment of the vehicle of FIG. 1 including another example vehicle climate control system.

FIG. 4 is a schematic diagram illustrating certain aspects of an example embodiment of the vehicle of FIG. 1 including another example vehicle climate control system.

FIG. 5 is a schematic diagram illustrating certain aspects of climate controls of the vehicle of FIG. 1.

### DETAILED DESCRIPTION OF EXAMPLE EMBODIMENTS

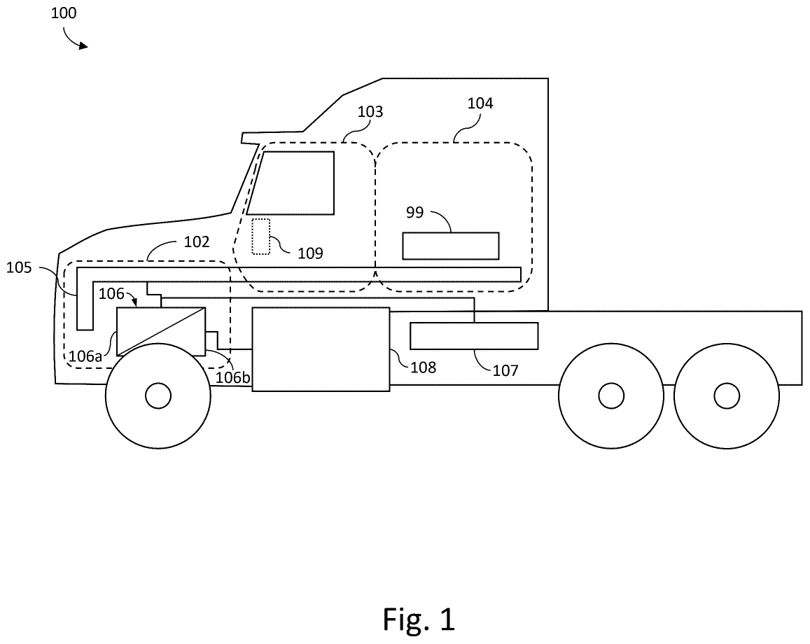

With reference to FIG. 1, there is illustrated an example vehicle 100 including a prime mover bay 102, a driver cab 103, and a sleeper cab 104. Prime mover bay includes a prime mover system 106 and certain components of a climate control system 105. Driver cab 103 includes driver controls 109 and certain components of climate control system 105. Driver controls 109 may comprise, for example, a steering wheel, accelerator pedal, brake pedal, and gear selector, among other controls as will occur to one of skill in the art with the benefit and insight of the present disclosure. Sleeper cab 104 includes a bed or other sleeping surface 99 and certain components of climate control system 105.

In the illustrated example, vehicle 100 is configured and provided in the form of a hybrid combustion-electric vehicle wherein prime mover system 106 includes an engine 106a and an electric drive system 106b. Engine 106a is operatively coupled with and configured to receive fuel from fuel tank 108 and to combust the received fuel to provide power to drive one or more wheels to propel vehicle 100.

Electric drive system 106b is operatively coupled with and configured to receive electrical power from energy storage system 107 to provide power to drive one or more wheels to propel vehicle 100. Energy storage system 107 is also configured to supply power to one or more components of climate control system 105 and one or more components of prime mover system 106.

Electric drive system 106b may be configured and provided in a number of configurations and architectures including, for example, a parallel hybrid, a series hybrid, a series-parallel hybrid, or other configuration and architectures as will occur to one if skill in the art with the benefit and insight of the present disclosure.

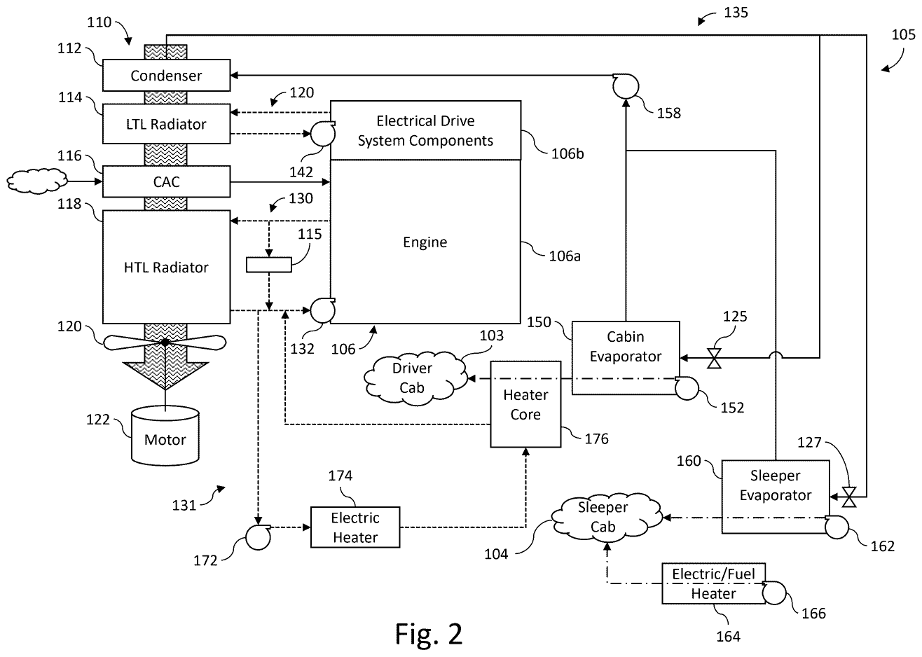

With reference to FIG. 2, there is illustrated an example embodiment of climate control system 105 and prime mover system 106 of vehicle 100. Engine 106a is operatively coupled with a coolant loop 130 which is also operatively coupled with a higher-temperature loop radiator 118, a coolant reservoir 115, and a coolant pump 132. In the illustrated example, coolant loop 130 includes a heating branch 131 including a heater coolant pump 172, a heater core 176, and an electric heater 174. Heater coolant pump 172 may be controlled and operated to circulate coolant through heater core 176 to warm air blown across heater core by blower 152 to heat driver cab 103.

Electric drive system 106b may be provided in a number of forms and may comprise various components. In some embodiments, electric drive system 106b may comprise one or more traction motor/generators configured and operable to provide drive torque to and capture regenerative braking energy from one or more wheels of vehicle 100, an energy storage system, and power electronics configured to transmit electrical power between the one or more traction motor/generators and the energy storage system. In other embodiments, electric drive system 106b may comprise additional or alternative components as will occur to one of skill in the art with the benefit and insight of the present disclosure. One or more components of electric drive system 106b is operatively coupled with a coolant loop 120 which is also operatively coupled with a lower-temperature loop radiator 114 and a coolant pump 142 which is configured to circulate coolant through one or more components of electric drive system 106b.

A higher-temperature loop radiator 118 and lower-temperature loop radiator 114 are configured and provided as components of a cooling stack 110 which, in the illustrated example, further comprises charge air cooler (CAC) 116, and condenser 112. A fan 120 is provided proximate cooling stack 110 and is configured and operable to provide airflow across cooling stack 110 as generally indicated by arrow F. An electric motor 122 is configured to drive fan 120 using electrical power received from energy storage system 107, for example, via power electronic associated with electrical drive system components or other power converters or power supplies associated with energy storage system 107. Ram air from operation of vehicle 100 may also contribute to the provision of airflow across cooling stack 110. It shall be appreciated that higher-temperature loop radiator 118 and lower-temperature loop radiator 114 are examples of heat exchangers according to the present disclosure. Other embodiments contemplate other arrangements, configurations, and types of heat exchangers as will occur to one of skill in the art with the benefit and insight of the present disclosure.

Condenser 112 is configured to be cooled by airflow through cooling stack 110. Condenser 112 is a component of a vapor compression loop which further comprises compressor 158, cabin evaporator 150, valve 125, valve 126, sleeper evaporator 160, valve 127, and valve 128. Compressor 158 compresses working fluid which flows through the refrigeration loop in a forward direction through refrigeration loop135, and condenser 112 and cabin evaporator 150 are configured to selectably operate as an air conditioner to cool driver cab 103 by cooling air blown across cabin evaporator 150 by blower 152. Similarly, in this configuration, condenser 112 and sleeper evaporator 160 are configured to selectably operate as an air conditioner to cool sleeper cab 104 by cooling air blown across sleeper evaporator 160 by blower 162.

Cabin evaporator 150, valve 125, valve 126 comprise components of a first branch of refrigeration loop 135. Valve 125 is configured and operable to control working fluid flow in a forward direction through cabin evaporator 150.

Sleeper evaporator 160, valve 127, and valve 128 comprise components of a second branch of the refrigeration loop 135. Valve 127 is configured and operable to control working fluid flow in a forward direction through sleeper evaporator 160.

Valve 125, valve 126, valve 127, and valve 128 are electronically controllable by electronic control system 96 and are one example of a valve system configured to selectably control circulation of refrigeration through the first branch of the refrigeration loop and a second branch of the refrigeration loop. Electronic control system 96 may comprise one or more controllers for controlling different aspects of vehicle 100. Electronic control system 96 may comprise one or more electronic control units (ECU) which may be comprised of digital circuitry, analog circuitry, or a hybrid combination of both of these types. Electronic control system 96 may comprise one or more Arithmetic Logic Units (ALUs), Central Processing Units (CPUs), non-transitory memories, limiters, conditioners, filters, format converters, or the like.

An electric or fuel heater 164 may also be provided to heat air blown into sleeper cab 104 by blower 166. In some embodiments. Heater 164 may be configured and provided to heat air blown into sleeper cab 104 by blower 162 and blower 166 may be omitted.

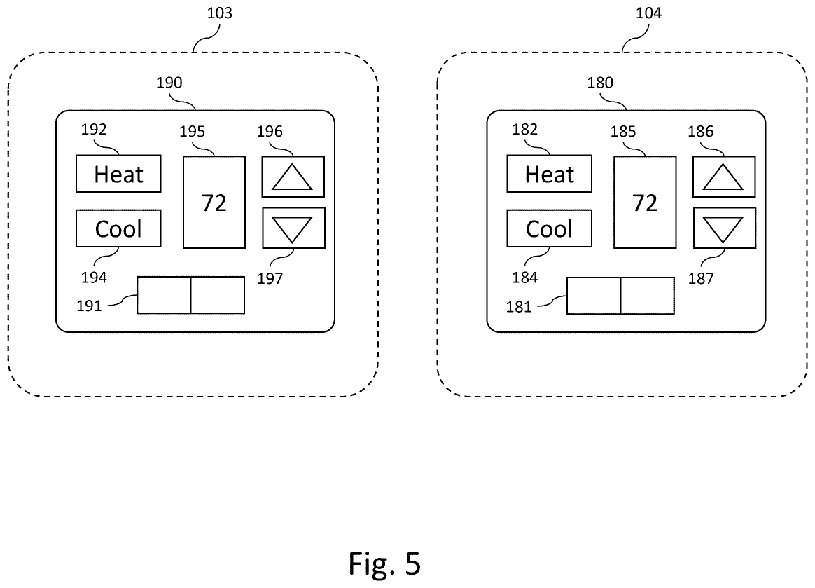

As illustrated in FIG. 5, electronic control system 96 may comprise operator controls 180 and operator controls 190 which are configured to selectably operate the first branch of the refrigeration loop to control climate of the driver cab of the vehicle and selectably operate the second branch of the refrigeration loop to control climate of the sleeper cab of the vehicle.

Operator controls 190 are provided at least in part in the driver cab 103. Operator controls 190 include selector switch 191 which is adjustable by an operator to select climate control settings for one of the driver cab (DC) and the sleeper cab (SC). Heat switch 192 is adjustable by an operator to select a heating mode for the selected one of the driver cab and the sleeper cab. Cool switch 194 is adjustable by an operator to select a cooling mode for the selected one of the driver cab and the sleeper cab. Selector switch 196 and selector switch 197 are adjustable by an operator to adjust a target temperature which may be displayed a visually perceptible display 195.

Operator controls 180 are provided at least in part in sleeper cab 104. Operator controls 180 include selector switch 181 which is adjustable by an operator to select climate control settings for one of the driver cab (DC) and the sleeper cab (SC). Heat switch 182 is adjustable by an operator to select a heating mode for the selected one of the driver cab and the sleeper cab. Cool switch 184 is adjustable by an operator to select a cooling mode for the selected one of the driver cab and the sleeper cab. Selector switch 186 and selector switch 187 are adjustable by an operator to adjust a target temperature which may be displayed a visually perceptible display 185.

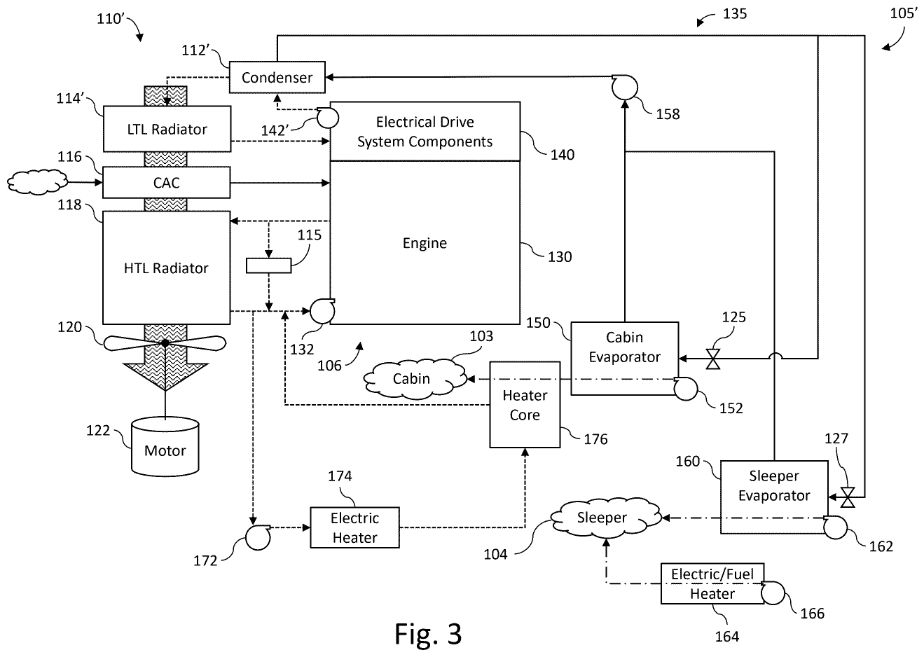

With reference to FIG. 3, there is illustrated another example embodiment of a climate control system 105′ and prime mover system 106 of vehicle 100. The embodiment of a climate control system 105′ of FIG. 3 includes a number of components, features, and functionalities that are the substantially the same as or similar to those of climate control system 105 illustrated and described in FIG. 2 and which are labeled with the same reference numerals utilized in connection with FIG. 2 and the description thereof. Climate control system 105′ also differs from climate control system 105 in certain respects. For example, in FIG. 3, condenser 112′ is configured and provided as a liquid cooled condenser rather than an air cooled condenser such as condenser 112. Condenser 112′ is provide in a working fluid loop comprising working fluid pump 142′, lower temperature loop radiator 114′, and one or more components of electrical drive system 140. Furthermore, cooling stack 110′ is similar to cooling stack 110 but omits an air cooled condenser.

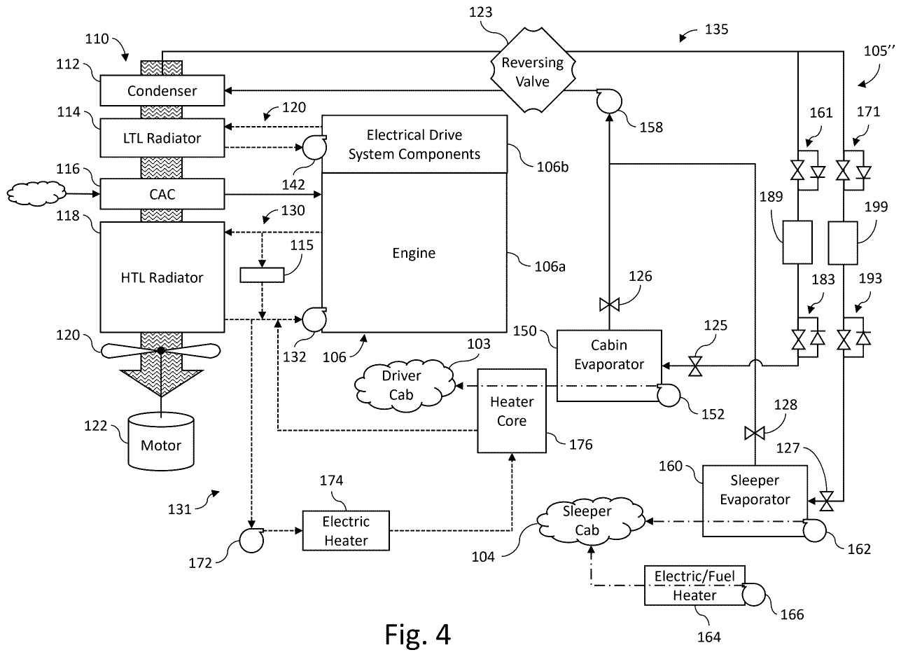

With reference to FIG. 4, there is illustrated another example embodiment of a climate control system 105″ and prime mover system 106 of vehicle 100. The embodiment of a climate control system 105″ of FIG. 4 includes a number of components, features, and functionalities that are the substantially the same as or similar to those of climate control system 105 illustrated and described in FIG. 2 and which are labeled with the same reference numerals utilized in connection with FIG. 2 and the description thereof. Climate control system 105″ also differs from climate control system 105 in certain respects. For example, in climate control system 105″, condenser 112 is a component of a vapor compression loop which further comprises compressor 158, reversing valve 123, cabin evaporator 150, valve 125, valve 126, sleeper evaporator 160, valve 127, and valve 128. Reversing valve 123 is configured and operable to selectably change a direction of working fluid flow through the refrigeration loop between a forward direction and a reverse direction. When reversing valve 123 is controlled and adjusted to a configuration providing provide the forward direction of working fluid flow through refrigeration loop 135, condenser 112 and cabin evaporator 150 are configured to selectably operate as an air conditioner to cool driver cab 103 by cooling air blown across cabin evaporator 150 by blower 152. Similarly, in this configuration, condenser 112 and sleeper evaporator 160 are configured to selectably operate as an air conditioner to cool sleeper cab 104 by cooling air blown across sleeper evaporator 160 by blower 162.

Cabin evaporator 150, valve 125, valve 126 comprise components of a first branch of refrigeration loop 135. Valve 125 is configured and operable to control working fluid flow in a forward direction through cabin evaporator 150. Valve 126 is configured and operable to control working fluid flow in a reverse direction through cabin evaporator 150.

Sleeper evaporator 160, valve 127, and valve 128 comprise components of a second branch of the refrigeration loop 135. Valve 127 is configured and operable to control working fluid flow in a forward direction through sleeper evaporator 160. Valve 128 is configured and operable to control working fluid flow in a reverse direction through sleeper evaporator 160.

Valves 161 are provided on one side of a dryer or receiver 189 and valves 183 are provided on another side of dryer or receiver 189. Valves 161 include a thermal expansion valve (TXV) and a check valve arranged in a parallel relationship. Valves 183 include a thermal expansion valve (TXV) and a check valve arranged in a parallel relationship. Valves 161, valves 183, and dryer or receiver 189 provide proper functionality when switching between an air conditioner mode and a heat pump mode.

Valves 171 are provided on one side of a dryer or receiver 199 and valves 193 are provided on another side of receiver 199. Valves 171 include a thermal expansion valve (TXV) and a check valve arranged in a parallel relationship. Valves 193 include a thermal expansion valve (TXV) and a check valve arranged in a parallel relationship. Valves 171, valves 193, and receiver or dryer 199 provide proper functionality when switching between an air conditioner mode and a heat pump mode.

As illustrated by this detailed description, the present disclosure contemplates a number of embodiments including the following examples.

Example embodiment number 1 is a vehicle system comprising: a prime mover system including an engine configured to combust fuel to power propulsion of the vehicle and an electric drive configured to power propulsion of the vehicle using electrical energy from an energy storage system; a cooling stack including a first heat exchanger operatively coupled with the engine and a second heat exchanger operatively coupled with the electric drive; a fan configured to circulate air across the cooling stack; an electric motor configured to drive the fan using energy from the energy storage system; a condenser configured to be cooled by the cooling stack; a first evaporator operatively coupled with the condenser by a first branch of a refrigeration loop; a first blower configured to circulate air across the first evaporator and into a driver cab of the vehicle; a second evaporator operatively coupled with the condenser by a second branch of the refrigeration loop; a second blower configured to circulate air across the second evaporator and into a sleeper cab of the vehicle; a pump configured to circulate refrigerant through the refrigeration loop; a valve system configured to selectably control circulation of refrigeration through the first branch of the refrigeration loop and a second branch of the refrigeration loop; and operator controls configured to selectably operate the first branch of the refrigeration loop to control climate of the driver cab of the vehicle and selectably operate the second branch of the refrigeration loop to control climate of the sleeper cab of the vehicle.

Example embodiment number 2 includes the features of example embodiment number 1, wherein the cooling stack is further configured to receive ram air during operation of the vehicle.

Example embodiment number 3 includes the features of example embodiment number 1, wherein the cooling stack includes a charge air cooler.

Example embodiment number 4 includes the features of example embodiment number 1, wherein the operator controls are provided at least in part in the driver cab.

Example embodiment number 5 includes the features of example embodiment number 1, wherein the operator controls are provided at least in part in the sleeper cab.

Example embodiment number 6 includes the features of example embodiment number 1, wherein the condenser is configured to be cooled by the air circulated across the cooling stack by the fan.

Example embodiment number 7 includes the features of example embodiment number 1, wherein the condenser is configured to be cooled by coolant circulated through a coolant loop including one or more components of the electric drive and the second heat exchanger.

Example embodiment number 8 includes the features of example embodiment number 1, wherein the cooling system includes a flow reversal valve configured to selectably change a direction of coolant flow through the refrigeration loop between a forward direction and a reverse direction.

Example embodiment number 9 includes the features of example embodiment number 8, wherein, when the flow reversal valve is configured to provide the forward direction of coolant flow through the refrigeration loop condenser, the first evaporator is configured to cool the driver cab and the second evaporator is configured to cool the sleeper cab.

Example embodiment number 10 includes the features of example embodiment number 8, when the flow reversal valve is configured to provide the reverse direction of coolant flow through the refrigeration loop condenser, the first evaporator is configured to heat the driver cab and the second evaporator is configured to heat the sleeper cab.

Example embodiment number 11 is a process for cooling a vehicle including a prime mover system including an engine configured to combust fuel to power propulsion of the vehicle and an electric drive configured to power propulsion of the vehicle using electrical energy from an energy storage system, a cooling stack including a first heat exchanger operatively coupled with the engine and a second heat exchanger operatively coupled with the electric drive, a first evaporator operatively coupled with a condenser by a first branch of a refrigeration loop, a second evaporator operatively coupled with the condenser by a second branch of the refrigeration loop, the process comprising: operating a fan to circulate air across the cooling stack; operating an electric motor to drive the fan using energy from the energy storage system; cooling the condenser with the cooling stack; operating a first blower to circulate air across the first evaporator and into a driver cab of the vehicle; operating a second blower to circulate air across the second evaporator and into a sleeper cab of the vehicle; operating a pump to circulate refrigerant through the refrigeration loop; operating a valve system to selectably control circulation of refrigeration through the first branch of the refrigeration loop and a second branch of the refrigeration loop; and adjusting operator controls to selectably operate one of the first branch of the refrigeration loop to control climate of the driver cab of the vehicle and the second branch of the refrigeration loop to control climate of the sleeper cab of the vehicle.

Example embodiment number 12 includes the features of example embodiment number 11, comprising cooling the cooling stack with ram air during operation of the vehicle.

Example embodiment number 13 includes the features of example embodiment number 11, wherein the cooling stack includes a charge air cooler.

Example embodiment number 14 includes the features of example embodiment number, wherein the operator controls are provided at least in part in the driver cab.

Example embodiment number 15 includes the features of example embodiment number 11, wherein the operator controls are provided at least in part in the sleeper cab.

Example embodiment number 16 includes the features of example embodiment number 11, comprising cooling the condenser by operating the fan to circulate air across the cooling stack.

Example embodiment number 17 includes the features of example embodiment number 11, comprising cooling the condenser by circulating coolant through a coolant loop including one or more components of the electric drive and the second heat exchanger.

Example embodiment number 18 includes the features of example embodiment number 11, comprising operating a flow reversal valve to selectably change a direction of coolant flow through the refrigeration loop between a forward direction and a reverse direction.

Example embodiment number 19 includes the features of example embodiment number 18, comprising controlling the flow reversal valve to provide the forward direction of coolant flow through the refrigeration loop, the condenser, and the second evaporator to cool the sleeper cab.

Example embodiment number 20 includes the features of example embodiment number 18, comprising controlling the flow reversal valve to provide the reverse direction of coolant flow through the refrigeration loop, the condenser, and the second evaporator to heat the sleeper cab.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A vehicle system comprising:
a prime mover system including an engine configured to combust fuel to power propulsion of the vehicle and an electric drive configured to power propulsion of the vehicle using electrical energy from an energy storage system;
a cooling stack including a first heat exchanger operatively coupled with the engine and a second heat exchanger operatively coupled with the electric drive;
a fan configured to circulate air across the cooling stack;
an electric motor configured to drive the fan using energy from the energy storage system;
a condenser configured to be cooled by the cooling stack;
a first evaporator operatively coupled with the condenser by a first branch of a refrigeration loop;
a first blower configured to circulate air across the first evaporator and into a driver cab of the vehicle;
a second evaporator operatively coupled with the condenser by a second branch of the refrigeration loop;
a second blower configured to circulate air across the second evaporator and into a sleeper cab of the vehicle;
a pump configured to circulate refrigerant through the refrigeration loop;
a valve system configured to selectably control circulation of refrigeration through the first branch of the refrigeration loop and a second branch of the refrigeration loop; and
operator controls configured to selectably operate the first branch of the refrigeration loop to control climate of the driver cab of the vehicle and selectably operate the second branch of the refrigeration loop to control climate of the sleeper cab of the vehicle.

2. The vehicle system of claim 1, wherein the cooling stack is further configured to receive ram air during operation of the vehicle.

3. The vehicle system of claim 1, wherein the cooling stack includes a charge air cooler.

4. The vehicle system of claim 1, wherein the operator controls are provided at least in part in the driver cab.

5. The vehicle system of claim 1, wherein the operator controls are provided at least in part in the sleeper cab.

6. The vehicle system of claim 1, wherein the condenser is configured to be cooled by the air circulated across the cooling stack by the fan.

7. The vehicle system of claim 1, wherein the condenser is configured to be cooled by coolant circulated through a coolant loop including one or more components of the electric drive and the second heat exchanger.

8. The vehicle system of claim 1, wherein the cooling system includes a flow reversal valve configured to selectably change a direction of coolant flow through the refrigeration loop between a forward direction and a reverse direction.

9. The vehicle system of claim 8, wherein, when the flow reversal valve is configured to provide the forward direction of coolant flow through the refrigeration loop condenser, the first evaporator is configured to cool the driver cab and the second evaporator is configured to cool the sleeper cab.

10. The vehicle system of claim 8, when the flow reversal valve is configured to provide the reverse direction of coolant flow through the refrigeration loop condenser, the first evaporator is configured to heat the driver cab and the second evaporator is configured to heat the sleeper cab.

11. A process for cooling a vehicle including a prime mover system including an engine configured to combust fuel to power propulsion of the vehicle and an electric drive configured to power propulsion of the vehicle using electrical energy from an energy storage system, a cooling stack including a first heat exchanger operatively coupled with the engine and a second heat exchanger operatively coupled with the electric drive, a first evaporator operatively coupled with a condenser by a first branch of a refrigeration loop, a second evaporator operatively coupled with the condenser by a second branch of the refrigeration loop, the process comprising:
operating a fan to circulate air across the cooling stack;
operating an electric motor to drive the fan using energy from the energy storage system;
cooling the condenser with the cooling stack;
operating a first blower to circulate air across the first evaporator and into a driver cab of the vehicle;
operating a second blower to circulate air across the second evaporator and into a sleeper cab of the vehicle;
operating a pump to circulate refrigerant through the refrigeration loop;
operating a valve system to selectably control circulation of refrigeration through the first branch of the refrigeration loop and a second branch of the refrigeration loop; and
adjusting operator controls to selectably operate one of the first branch of the refrigeration loop to control climate of the driver cab of the vehicle and the second branch of the refrigeration loop to control climate of the sleeper cab of the vehicle.

12. The process of claim 11, comprising cooling the cooling stack with ram air during operation of the vehicle.

13. The process of claim 11, wherein the cooling stack includes a charge air cooler.

14. The process of claim 11, wherein the operator controls are provided at least in part in the driver cab.

15. The process of claim 11, wherein the operator controls are provided at least in part in the sleeper cab.

16. The process of claim 11, comprising cooling the condenser by operating the fan to circulate air across the cooling stack.

17. The process of claim 11, comprising cooling the condenser by circulating coolant through a coolant loop including one or more components of the electric drive and the second heat exchanger.

18. The process of claim 11, comprising operating a flow reversal valve to selectably change a direction of coolant flow through the refrigeration loop between a forward direction and a reverse direction.

19. The process of claim 18, comprising controlling the flow reversal valve to provide the forward direction of coolant flow through the refrigeration loop, the condenser, and the second evaporator to cool the sleeper cab.

20. The process of claim 18, comprising controlling the flow reversal valve to provide the reverse direction of coolant flow through the refrigeration loop, the condenser, and the second evaporator to heat the sleeper cab.
